(19) United States
(12) Patent Application Publication
(10) Pub. No.: US 2020/0209669 A1
(43) Pub. Date: Jul. 2, 2020

(54) ELECTRO-OPTICAL UNIT FOR VOLUMETRIC DISPLAY DEVICE

(71) Applicant: Lightspace Technologies, SIA, Marupe (LV)

(72) Inventors: Ilmars Osmanis, Marupe (LV); Robers Zabels, Riga (LV); Ugis Gertners, Riga (LV); Martins Narels, Riga (LV); Kriss Osmanis, Babites pagasts (LV); Ainars Ozols, Siguldas pagasts (LV)

(21) Appl. No.: 16/235,345

(22) Filed: Dec. 28, 2018

(51) Int. Cl. G02F 1/1347; G02F 1/137; G02F 1/1333; G02B 27/22; G02F 1/1339

(52) U.S. Cl. CPC G02F 1/13476; G02F 1/137; G02F 1/133308; G02F 2202/28; G02F 1/13392; G02F 2001/13756; G02B 27/2278

(57) ABSTRACT

An electro-optical unit for a volumetric display device is disclosed. The electro-optical unit includes first optical diffuser element including first substrate and second substrate, first electrode arranged on inner side of the first substrate and second electrode arranged on inner side of the second substrate, and first liquid crystal layer arranged between the first electrode and the second electrode; and a second optical diffuser element including third substrate and fourth substrate, third electrode arranged on inner side of third substrate and fourth electrode arranged on inner side of the fourth substrate, and second liquid crystal layer arranged between third electrode and fourth electrode. Further, the electro-optical unit includes a first transitional medium layer arranged between the first optical diffuser element and the second optical diffuser element, with a refractive index equivalent to a refractive index of one or more of the fourth substrate and the fifth substrate.

### TECHNICAL FIELD

The present disclosure relates generally to optical display arrangements, such as volumetric display devices; and specifically, to an electro-optical unit for displaying three-dimensional images in volumetric display devices.

### BACKGROUND

Typically, a visual content conveys an idea and/or an emotion that is perceivable by a human brain in a better manner than a non-visual content. Therefore, representation of the visual content on digital platforms has gained utmost importance over the years. Conventionally, two-dimensional (or 2D) displays such as computer monitors, televisions, portable displays and so forth have been used for representation of 2D digital visual content, such as images, videos, graphics interchange format (gif) based content. However, the 2D digital visual content lacks distances, proportions, and other depth-related details. With the advancement in technology, techniques have been developed that are capable of representing the digital visual content in a three-dimensional (or 3D) format. Traditionally, a stereoscopic representation technique is used for representing the 3D digital visual content. Such technique depicts a slightly altered view of the 3D content to each eye of the user, thereby causing binocular disparity and vergence driven depth sensation. Furthermore, a variety of software-based techniques may be employed to incorporate additional information into the three-dimensional videos. For example, techniques such as linear perspective, shading, occlusion, textures and so forth may be employed to enable presentation of depth cues within the three-dimensional videos to the viewers. However, such conventional presentation techniques are associated with a multitude of problems.

Volumetric display devices, such as virtual reality (VR) headsets, augmented reality (AR) headsets and etc., have been developed which are capable of presenting the 3D digital visual content. Different types of volumetric display devices employ different techniques to generate 3D digital visual content. One of techniques involves using an opto-electric device utilizing a variable-focal lens. Such a technique has a few limitations such as limited number of depth planes, a limited image refresh rate and so forth, thereby limiting a viewing experience of the user. Other techniques employing volumetric displays includes devices based on digital optical path modulation, multi-view type volumetric screens and so forth. However, such techniques suffer from issues such as reflections between image depth planes which cause reduction in brightness and contrast in the 3D digital visual content.

Therefore, in light of the foregoing discussion, there exists a need to overcome the aforementioned drawbacks associated with volumetric display devices.

### SUMMARY

The present disclosure seeks to provide an electro-optical unit for a volumetric display device. The electro-optical unit of the present disclosure provides a solution to the existing problem of reflections between the image depth planes. An aim of the present disclosure is to provide a solution that overcomes at least partially the problems encountered in prior art, and provides the electro-optical unit configured to display a 3D imagery content free of unwanted internal reflections, a 3D imagery content having an enhanced brightness and a contrast and so forth.

In one aspect, an embodiment of the present disclosure provides an electro-optical unit for a volumetric display device, the electro-optical unit comprising:

a first optical diffuser element comprising a first substrate and a second substrate, a first electrode arranged on an inner side of the first substrate and a second electrode arranged on an inner side of the second substrate, and a first liquid crystal layer arranged between the first electrode and the second electrode;

a second optical diffuser element comprising a third substrate and a fourth substrate, a third electrode arranged on an inner side of the third substrate and a fourth electrode arranged on an inner side of the fourth substrate, and a second liquid crystal layer arranged between the third electrode and the fourth electrode, wherein the second optical diffuser element is arranged spaced apart from the first optical diffuser element such that the second substrate and the third substrate are facing each other; and

a first transitional medium layer arranged between the first optical diffuser element and the second optical diffuser element to be in contact with an outer side of the second substrate and an outer side of the third substrate therein, wherein the first transitional medium layer has a refractive index equivalent to a refractive index of one or more of the second substrate and the third substrate.

Embodiments of the present disclosure substantially eliminate or at least partially address the aforementioned problems in the prior art, and enable recreation of the 3D imagery content on the electro-optical unit that is substantially free from reflections. Furthermore, the 3D imagery content recreated has an enhanced brightness and contrast.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a volumetric display device comprising an electro-optical unit having optical diffuser elements receiving image slices of an image, in accordance with an exemplary embodiment of the present disclosure;

FIG. 2 is an illustration of a cross-section of an optical diffuser element, in accordance with an exemplary embodiment of the present disclosure;

FIGS. 3A-3B are illustrations of cross-sections of an electro-optical unit, in accordance with two different embodiments of the present disclosure;

FIGS. 4A-B are schematic illustrations of an electro-optical unit being arranged in a frame, in accordance with two different embodiments of the present disclosure;

FIG. 5A is an illustration of a partial exploded view of an arrangement of an electro-optical unit with an optical diffuser element arranged with respect to a rigid interlayer for assembly thereof, in accordance with an embodiment of the present disclosure;

FIG. 5B is an illustration of an assembly of an electro-optical unit comprising optical diffuser elements arranged in rigid interlayers, in accordance with an embodiment of the present disclosure;

FIG. 6 is an illustration of an electro-optical unit having double-sided substrates, in accordance with an embodiment of the present disclosure; and

FIG. 7 is an illustration of a volumetric display device comprising an electro-optical unit, in accordance with another embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides an electro-optical unit for a volumetric display device, the electro-optical unit comprising:

a first optical diffuser element comprising a first substrate and a second substrate, a first electrode arranged on an inner side of the first substrate and a second electrode arranged on an inner side of the second substrate, and a first liquid crystal layer arranged between the first electrode and the second electrode;

a second optical diffuser element comprising a third substrate and a fourth substrate, a third electrode arranged on an inner side of the third substrate and a fourth electrode arranged on an inner side of the fourth substrate, and a second liquid crystal layer arranged between the third electrode and the fourth electrode, wherein the second optical diffuser element is arranged spaced apart from the first optical diffuser element such that the second substrate and the third substrate are facing each other; and

a first transitional medium layer arranged between the first optical diffuser element and the second optical diffuser element to be in contact with an outer side of the second substrate and an outer side of the third substrate therein, wherein the first transitional medium layer has a refractive index equivalent to a refractive index of one or more of the second substrate and the third substrate.

The present disclosure provides the electro-optical unit for utilization in the volumetric display devices. The electro-optical unit comprises at least two optical diffuser elements configured to function as image depth planes. The image depth planes provide a proper physical and psychological depth cue to an imagery content in order to reproduce a 3D imagery content for a viewer.

Generally, an image processing unit is configured to receive the imagery content and further segregate the imagery content into a plurality of image portions (slices) based on depth of scene in the imagery content. Such techniques and algorithms for image slicing are known in the art and have not been described herein for brevity of the present disclosure. Furthermore, the plurality of image slices are received by a projection unit which is configured to direct the plurality of image slices to the electro-optical unit of the volumetric display one by one in a time multiplexed manner. The projection unit directs each image slice of the plurality of image slices on one of the optical diffuser elements. The optical diffuser elements are optically active elements that interact with light differently, upon application and removal of an electric field thereto. Usually, the incident light comprises visible spectrum of light; however, the incident light may include near infrared and/or ultraviolet spectrum of the light. In the volumetric display device, an image slice having a subject closer in a view of the imagery content is directed and focused on the optical diffuser element nearer to the viewer, whereas an image slice having a subject far in the view of the imagery content is directed on the optical diffuser element far from the viewer, thereby creating a depth required for the imagery content. The plurality of image slices directed separately on the optical diffuser elements provide depth to the imagery content, thereby providing the imagery content having a certain depth as the output of the volumetric display device.

Herein, the optical diffuser elements are configured to switch between two states, namely, a substantially transparent optical state and a substantially diffusing optical state. The optical diffuser elements in the substantially diffusing optical state acts as an imagery content receiving screen, thereby allowing the viewer to view the corresponding image slice thereon. It will be appreciated that only one of the optical diffuser elements is in the substantially diffusing optical state at a given instant of time. Furthermore, the switching between the two states of the optical diffuser elements occurs rapidly, thereby providing a visibly continuous 3D imagery content to the viewer.

In the electro-optical unit of the present disclosure, the at least two optical diffuser elements are constructed using materials that have substantially matching refractive indexes. That is, each of the optical diffuser elements is indexed matched with that of the adjacent optical diffuser element, so as to avoid any distortions in the produced 3D imagery content caused by the unmatched refractive indexes while light travels between adjacent optical diffuser elements. The matching of refractive indexes of two adjacent mediums is of importance as when the light passes through a boundary of the adjacent mediums, the light tends to bend and distort if the refractive indexes of the adjacent mediums is not generally equivalent. Therefore, to avoid any distortions of the light passing from one medium to another medium it is required to match the refractive indexes of the two mediums at the boundary of contact thereof. Therefore, the electro-optical unit is able to generate 3D imagery content substantially free of any distortions that may have been caused by the unwanted reflections between different layers in the electro-optical unit.

The term “volumetric display device” as used throughout the present disclosure, relates to display devices that are capable of presenting one or more images (or videos) thereon. Examples of such display devices include televisions, computer monitors, portable device displays and so forth. Further, the volumetric display devices include display devices that can be positioned near eyes of a user thereof, such as, by allowing the user to wear (by mounting) the near-eye display apparatus on a head thereof. Examples of such near-eye display apparatuses include, but are not limited to, head mounted displays (HMDs), head-up displays (HUDs), virtual-reality display devices, augmented-reality display devices, stereoscopic display devices and so forth. In present examples, the volumetric display device is a multi-planar display device that is capable of presenting 3-dimensional (or 3D) images or videos thereon.

The volumetric display device comprises the electro-optical unit arranged with respect to the projection unit (as discussed above) to receive the projected images slices. The electro-optical unit comprises a plurality of optical diffuser elements (such as screens) that are operable to be sequentially enabled to display the image portion (or the image slice) of the 3D image (or video) thereon. Furthermore, when various portions of the 3D imagery content are sequentially displayed on the plurality of optical diffuser elements at a fast cycling rate (or image refresh rate), a viewer perceives the 3-dimensional nature (or depth) associated with the 3D imagery content.

It will be appreciated that the image refresh rate is a product of the number of displayable image depth planes (such as the plurality of optical diffuser elements) and the desired image refresh rate. Notably, for an observance of a continuous perceptually flicker-free 3D imagery content, the image refresh rate should preferably be higher than 30 Hertz. Optionally, the image refresh rate should preferably be equal or higher than 50 Hertz. Moreover, to entirely eliminate a possibility of flicker perception associated with a persistence of vision within different regions of a retina of an eye of the viewer, the image refresh rate should preferably be equal or higher than 90 Hertz.

Generally, the optical diffuser elements are planar structures; however, the optical diffuser elements may have a curved shape without any limitations. The following description for the simplicity of concept will concentrate on strictly planar configuration of optical diffuser elements but it will be appreciated by a person skilled in the art that the same principles may be applied to curved and differently-shaped optical diffuser elements as well.

The electro-optical unit for the volumetric display device comprises the first optical diffuser element comprising the first substrate and the second substrate, wherein the first electrode is arranged on the inner side of the first substrate and the second electrode is arranged on the inner side of the second substrate, and wherein the first liquid crystal layer is arranged between the first electrode and the second electrode. Herein, the first liquid crystal layer, arranged between the first electrode and the second electrode, is an optically active layer configured to react with the incident light differently on application of voltage. The first substrate and the second substrate of the first optical diffuser element forms a cell wall type of a structure with their inner sides facing each other. The first substrate and the second substrate are constructed by using an optically transparent insulating material. Moreover, the first electrode and the second electrode are arranged on the inner side of the first substrate and on the inner side of the second substrate, respectively. Optionally, the first electrode and the second electrode are constructed using the optically transparent insulating material, such as an indium tin oxide (ITO). Alternatively, the first electrode and the second electrode are constructed using an optically transparent and conducting material, such as doped Zinc oxide (ZnO), metallic nanowire mesh, graphene and so forth. Herein, a thickness of any of the first substrate and the second substrate is defined as a distance between an inner side and an outer side thereof. Usually, a thickness of the first electrode and the second electrode is less as compared to the thickness of the respective first substrate and the second substrate. Generally, the thickness of the first electrode is in the range of 20-150 nanometers. In an example, the thickness of the first substrate is about 0.5 millimeters and the thickness of the first electrode is about 40 nanometers.

In an embodiment, an outer side of the first substrate is provided with one or more of an anti-reflective coating, an oleophobic coating, a hydrophobic coating and a tempered glass. It may be understood that the outer side of the first substrate is an outermost surface of the electro-optical unit which may be exposed to environment conditions like stray lights, dust, dirt, etc., thus it may be desired to provide an extra protection coating thereto. Generally, the outer side of the first substrate may be laminated with a coating such as the anti-reflective coating, the oleophobic coating, the hydrophobic coating and/or the tempered glass. Optionally, the outer side of the first substrate may be laminated with a tough, scratch resistant, impact resistant, light-transparent material layer protecting the first optical diffuser element from outside damage. The anti-reflective coating may be provided to minimize unwanted reflections on the first optical diffuser element, when the electro-optical unit is utilized in an ambient air environment.

In an embodiment, the first optical diffuser element comprises at least one dielectric barrier layer arranged between the first electrode and the first liquid crystal layer, and is arranged in contact with the first electrode at a first side thereof and the first liquid crystal layer at a second side thereof. The at least one dielectric barrier layer is arranged between the first electrode and the first liquid crystal layer. Specifically, the first optical diffuser element is provided with two dielectric barrier layers which are arranged at inner sides of the first electrode and the second electrode, such that the two dielectric barrier layers are arranged between the electrodes and the first liquid crystal layer. The at least one dielectric barrier layer is configured to provide an improved dielectric strength of the first liquid crystal layer, thereby increasing a threshold value for a breakdown voltage associated with the first optical diffuser element. Moreover, the at least one dielectric barrier layer limits a migration of impurities into the first liquid crystal layer from surroundings thereof. Optionally, the at least one dielectric barrier layer is composed of a solitary layer of an organic and/or an inorganic material. More optionally, the at least one dielectric barrier layer is composed of a compound layer consisting of the organic and/or the inorganic materials. In an example, the at least one dielectric barrier layer is implemented as an SiOx layer, wherein a thickness of the at least one dielectric barrier layer ranges from 20 nanometers to 200 nanometers. In an example, the at least one dielectric barrier layer is formed using various deposition techniques, such as vacuum deposition technique including but not limited to atomic layer deposition techniques; or flexo-printing technique and so forth.

In an embodiment, a refractive index of the at least one dielectric barrier layer is tuned to gradually vary between the first side and the second side thereof, to be matched to one or more of the refractive indexes of the first electrode and of the first liquid crystal layer at respective sides thereof. In particular, the refractive index at the first side of the at least one dielectric barrier layer is equivalent to the refractive index of the first liquid crystal layer in the substantially transparent optical state thereof. Optionally, the refractive index of the at least one dielectric barrier layer (such as SiOxNy layer) can be varied within a considerable range of 1.5-2. The refractive index of the at least one dielectric barrier layer is gradually varied such that the refractive index at the first side of the at least one dielectric barrier layer matches with that of the first electrode, and the refractive index at the second side of the at least one dielectric barrier layer matches with that of the first liquid crystal layer.

In another embodiment, a value of refractive index of the at least one dielectric barrier layer is between values of the refractive indexes of the first electrode and of the first liquid crystal layer at respective sides thereof. In particular, the value of refractive index of the at least one dielectric barrier layer is between values of the refractive indexes of the first electrode and of the first liquid crystal layer in the substantially transparent optical state thereof. In one example, the value of refractive index of the at least one dielectric barrier layer may be an average of the values of the refractive indexes of the first electrode and of the first liquid crystal layer. In another example, the value of refractive index of the at least one dielectric barrier layer may be any intermediate value between the values of the refractive indexes of the first electrode and of the first liquid crystal layer.

In the present embodiments, the at least one dielectric barrier layer may be a stacked structure of the inorganic and/or organic thin films layered to minimize the mismatch of refractive index between the first electrode and the liquid crystal layer. In an example, the organic thin films used within the stack of the at least one dielectric barrier layer may be polyimides and related organic materials. As discussed, the matching of refractive indexes of two adjacent mediums is of importance as when the light passes through a boundary of the adjacent mediums, the light tends to bend and distort if the refractive indexes of the adjacent mediums is not nearly similar. Therefore, to avoid any distortions of the light passing from one medium to another medium it is required to match the refractive indexes of the two mediums at the boundary of contact thereof. Furthermore, a minimization of parasitic reflections from an internal interface of the first optical diffuser element, such as the interface between the first liquid crystal layer and the first substrate (and any layers in between), is of importance to ensure improved brightness, contrast and viewability of the 3D imagery content, particularly in complicated (such as brightly lit) ambient conditions.

Furthermore, optionally, two busbars are provided at an end of each of the first electrode and the second electrode for application of voltage thereto. In an example, the two busbars may be thin extended copper strips soldered to each of the first electrode and the second electrode or attached to each of the first electrode and the second electrode in order to ensure a substantially low electrical resistance between the first and second electrodes and the corresponding busbar. Notably, when no voltage, and thereby no electric field, is applied across the first optical diffuser element, the first liquid crystal layer possesses a focal-conic texture that has light diffusing properties and is in the substantially diffusing optical state; whereas upon application of a sufficient voltage, and thereby electric field, the first liquid crystal layer possesses a homeotropic texture characterized by high light transparency and is in the substantially transparent optical state.

Furthermore, optionally, the electro-optical device further comprises one or more spacers arranged in the first optical diffuser element to maintain a gap between the first substrate and the second substrate thereof. Herein, a refractive index of the one or more spacers is equivalent to a refractive index of the first liquid crystal layer. The one or more spacers are fixed in place and have a diameter (or height) equal to a distance between the first substrate and the second substrate (in order to maintain the gap therebetween). Optionally, the one or more spacers may be constructed using an insulating light transparent materials, such as, a glass or a polymer material. The one or more spacers may be spherical in shape arranged in a defined volume between the first electrode and the second electrode, such that a diameter of the one or more spacers is equivalent to a distance between the first electrode and the second electrode. Optionally, the diameter of the one or more spacer spheres is within a range of 4 micrometers to 30 micrometers. More optionally the diameter of the one or more spacer spheres is within a range of 10 micrometers to 20 micrometers.

Alternatively, the one or more spacers may be manufactured by employing photolithography technique, wherein the one or more spacers is composed of a layer of a photoresist material. Alternatively, optionally, the one or more spacers may be 3D printed. It will be appreciated that a refractive index of the one or more spacers is matched with the liquid crystal layer in the substantially transparent optical state. Further, it will be appreciated that a density of the one or more spacers is kept sufficiently high in order to protect the first optical diffuser element from failure. Additionally, optionally, an adhesive layer may be used on a surface of the one or more spacers spheres in order to avoid a migration of the one or more spacers within the liquid crystal layer.

Optionally, a seal may be provided around a perimeter of the first optical diffuser element, such as to exclude an exposure of the first liquid crystal layer to the ambient surroundings, thereby limiting a possibility of contamination in the first liquid crystal layer. In an example, the seal may be constructed using a polymer material or a blend of one or more polymer materials such as a type of epoxy resin material or an ultraviolet (UV) curable epoxy resin material.

Furthermore, the electro-optical unit for the volumetric display device comprises the second optical diffuser element comprising a third substrate and a fourth substrate, a third electrode arranged on an inner side of the third substrate and a fourth electrode arranged on an inner side of the fourth substrate, and a second liquid crystal layer arranged between the third electrode and the fourth electrode, wherein the second optical diffuser element is arranged spaced apart from the first optical diffuser element such that the second substrate and the third substrate are facing each other. In an embodiment, the second optical diffuser element comprises at least one dielectric barrier layer arranged between the third electrode and the second liquid crystal layer, and is arranged in contact with the third electrode at a first side thereof and the second liquid crystal layer at a second side thereof. In an embodiment, a refractive index of the at least one dielectric barrier layer is tuned to gradually vary between the first side and the second side thereof, to be matched to one or more of the refractive indexes of the third electrode and of the second liquid crystal layer at respective sides thereof. In an embodiment, the electro-optical device further comprises one or more spacers arranged in the second optical diffuser element to maintain a gap between the third substrate and the fourth substrate thereof, wherein a refractive index of the one or more spacers is equivalent to a refractive index of the second liquid crystal layer. Optionally, a seal may be provided around a perimeter of the second optical diffuser elements, such as to exclude an exposure of the second liquid crystal layer to the ambient surroundings, thereby limiting a possibility of contamination in the second liquid crystal layer. These layers of the second optical diffuser element, including the third substrate and the fourth substrate, the at least one dielectric barrier layer, the one or more spacers, seal, etc., may generally be made of similar materials and may have similar inherent properties as that of the corresponding layers of the first optical diffuser element.

In an embodiment, the first liquid crystal layer and the second liquid crystal layer are configured to independently switch between the substantially transparent optical state and the substantially diffusing optical state upon application of different voltage values thereto, and wherein the refractive indexes of the second substrate and the third substrate are equivalent to refractive indexes of the respective first liquid crystal layer and the second liquid crystal layer in the substantially transparent optical states thereof. The first liquid crystal layer and the second liquid crystal layer are able to switch between the substantially transparent optical state and the substantially diffusing optical state rapidly (such as in an order of tens to hundreds of microseconds), such that the eye of the viewer is unable to detect the switching. Notably, the switching occurs on an application of the different voltage values.

Optionally, the switching may be accomplished in a progressive manner, wherein the each of the electro-optical elements are configured to switch to the substantially diffusing optical state sequentially. Notably, with such sequencing, the electro-optical element that is in the substantially diffusing optical state is configured to display the portion of the imagery content projected thereupon. Alternatively, the switching may be accomplished in an interlaced manner, wherein every alternate electro-optical element is switched to the substantially diffusing optical state. With such sequencing, the image refresh rate doubles, thereby enabling the viewer to receive flicker free 3D imagery content.

It will be appreciated that only one optical diffuser element will be in the substantially diffusing optical state at a given instant of time, and the remaining optical diffuser elements will be in the substantially transparent optical state. During the substantially transparent optical state of any one of the two liquid crystal layers, the incident light directed thereupon virtually remains unaffected and therefore, it can freely pass therethrough. During the substantially diffusing optical state of any one of the two liquid crystal layers, the incident light directed thereupon scatters in a forward direction, therefore, the respective optical diffuser element acts as the imagery receiving screen. The viewer is able to observe a sharp imagery content, when the optical diffuser element is in the substantially diffusing optical state. However, when the optical diffuser element is in the substantially transparent optical state, the imagery is not formed thereon and that optical diffuser element may be required to allow substantially all of the light through thereof for forming image at the next optical diffuser element or the eyes of the viewer. Therefore, it may be understood that the refractive index of the first substrate and the second substrate is matched to the refractive index of the first liquid crystal layer in the substantially transparent optical state, and the refractive index of the third substrate and the fourth substrate is equivalent to the refractive index of the second liquid crystal layer in the substantially transparent optical state, so that each of the optical diffuser elements provides uninhibited transmission of light through thereof without much reflections from the corresponding substrates due to unmatched refractive indexes from corresponding liquid crystal layer, when in the substantially transparent optical state.

Furthermore, the electro-optical unit for the volumetric display device comprises the first transitional medium layer arranged between the first optical diffuser element and the second optical diffuser element to be in contact with the outer side of the second substrate and the outer side of the third substrate therein, wherein the first transitional medium layer has the refractive index equivalent to the refractive index of one or more of the second substrate and the third substrate. The first transitional medium layer is provided between the first optical diffuser element and the second optical diffuser element, wherein the first transitional medium layer is typically a thin layer. The refractive index of the first transitional medium layer is equivalent to the one or more of the second substrate and the third substrate in order to avoid any distortions in the incident light that are likely to occur at the boundaries of the first transitional medium layer and the corresponding substrate. Preferably, the refractive indexes of both the second substrate and the third substrate are matched, and the refractive index of the first transitional medium layer is equivalent to that of both the second substrate and the third substrate. Therefore, in the present electro-optical unit, the optical diffuser elements provide uninhibited transmission of light between each other without much reflections at the boundaries between the corresponding substrates due to index matching by the first transitional medium layer.

In an embodiment, the first transitional medium layer comprises one or more of an optically transparent viscous resin and an optically transparent adhesive to hold the first optical diffuser element and the second optical diffuser element together. In an example, the first transitional medium layer may be implemented in the form of a lamination or a coating. In one or more examples, the first optical diffuser element, the second optical diffuser element and the first transitional medium layer are pressed together to expel any possible air bubbles from the first transitional medium layer.

In an embodiment, the optical diffuser elements are held together to form a monolith structure. Thereby, the assembled or formed electro-optical unit is a monolith structure. Herein, the purpose of using the first transitional medium layer is further to provide the electro-optical unit a structural strength. Notably using the optically transparent adhesive forms a generally permanent solid seal between the optical diffuser elements, in the electro-optical unit. Further using the optically transparent viscous resin may hold the optical diffuser elements due to capillary forces. Such arrangement may allow to better manage effects associated with thermal expansion between the optical diffuser elements, in the electro-optical unit. Moreover, if one of the optical diffuser elements may get damaged (e.g., dielectric breakdown of any active medium therein), then the electro-optical unit may be repaired by disassembling due to weak capillary forces and replacing the damaged optical diffuser element.

In an embodiment, the electro-optical unit further comprises a third optical diffuser element comprising a fifth substrate and a sixth substrate, a fifth electrode arranged on an inner side of the fifth substrate and a sixth electrode arranged on an inner side of the sixth substrate, and a third liquid crystal layer arranged between the fifth electrode and the sixth electrode, wherein the third optical diffuser element is arranged spaced apart from the second optical diffuser element such that the fourth substrate and the fifth substrate are facing each other. In an embodiment, an outer side of the sixth substrate is provided with one or more of the anti-reflective coating, the oleophobic coating, the hydrophobic coating and the tempered glass. In an embodiment, the third optical diffuser element comprises at least one dielectric barrier layer arranged between the fifth electrode and the third liquid crystal layer, and is arranged in contact with the fifth electrode at a first side thereof and the third liquid crystal layer at a second side thereof. In an embodiment, the refractive index of the at least one dielectric barrier layer is tuned to gradually vary between the first side and the second side thereof, to be matched to one or more of the refractive indexes of the fifth electrode and of the third liquid crystal layer at respective sides thereof. In an embodiment, the electro-optical device further comprises one or more spacers arranged in the third optical diffuser element to maintain the gap between the fifth substrate and the sixth substrate thereof, wherein the refractive index of the one or more spacers is equivalent to a refractive index of the third liquid crystal layer. Optionally, a seal may be provided at a perimeter of the third optical diffuser element, such as to exclude an exposure of the third liquid crystal layer to the ambient surroundings, thereby limiting a possibility of contamination in the third liquid crystal layer. These layers of the third optical diffuser element, including the fifth substrate and the sixth substrate, the at least one dielectric barrier layer, the one or more spacers, the seal, etc., may generally be made of similar materials and may have similar inherent properties as that of the corresponding layers of the first optical diffuser element and/or the second optical diffuser element.

In an embodiment, the third liquid crystal layer is configured to switch between a substantially transparent optical state and a substantially diffusing optical state upon application of different voltage values thereto, and wherein the refractive index of the fifth substrate is equivalent to a refractive index of the third liquid crystal layer in the substantially transparent optical state thereof. The switching of the third liquid crystal layer may take place in a substantially similar manner as that of the first liquid crystal layer and the second liquid crystal layer (as discussed in the preceding paragraphs).

In an embodiment, the electro-optical unit comprises a second transitional medium layer arranged between the second optical diffuser element and the third optical diffuser element to be in contact with an outer side of the fourth substrate and an outer side of the fifth substrate therein, wherein the second transitional medium layer has a refractive index equivalent to a refractive index of one or more of the fourth substrate and the fifth substrate. Again, the second transitional medium layer may generally be made of similar materials and may have similar inherent properties as that of the first transitional medium layer between the first optical diffuser element and/or the second optical diffuser element. Generally, the second transitional medium layer hold together the second optical diffuser element and the third optical diffuser element to provide the electro-optical unit a monolith structure.

In an embodiment, the first liquid crystal layer and the second liquid crystal layer, and the second liquid crystal layer and the third liquid crystal layer are arranged either equidistant from each other or at different distances from each other. In other words, each of the optical diffuser elements may be either equally arranged or unequally arranged. It will be appreciated that, a virtual appearance of the depth planes (characterized by the liquid crystal layer of the optical diffuser elements) is determined by the distances between each of the optical diffuser elements. Notably, the distances between the corresponding optical diffuser elements varies according to an application of the electro-optical unit for the volumetric display device for providing varying depth ranges. For instance, when an electro-optical unit comprising three optical diffuser elements is manufactured to view landscapes as a 3D view, a distance between the optical diffuser element farthest from the viewer and the middle optical diffuser element is kept more than a distance between the optical diffuser element nearest to the viewer and the middle optical diffuser element, as such an arrangement allows an attainment of a greater relative image depth.

In an embodiment, a thickness of one or more of the first substrate, the second substrate, the third substrate and the fourth substrate is different than a thickness of one or more of the fifth substrate and the sixth substrate. The first substrate and the second substrate may have a thickness more or less than the third and the fourth substrates. Moreover, the third and the fourth substrates may have a thickness more or less than the fifth and the sixth substrates. In an example, thickness of the substrates may be in the range of 0.15 millimeters to 2 millimeters.

Herein, a thickness of one or more of the second substrate and the third substrate is equal to 0.15 millimeters, and a thickness of one or more of the fourth substrate and the fifth substrate is equal to or more than 0.15 millimeters. It will be appreciated that different thickness of the substrates enables to achieve unequal distances between the liquid crystal layers of each of the optical diffuser elements, which may be required to achieve the relative depth effect as required for the imagery content (as discussed above).

In an embodiment, the unequal distance between the liquid crystal layers may be achieved by using the transitional medium layers of different thicknesses. Optionally, a thickness of the first transitional medium layer is in the range of 0.05 to 0.2 millimeters and a thickness of the second transitional medium layer is equal to or more than the thickness of the first transitional medium layer.

In an embodiment, the electro-optical unit further comprises a frame having multiple spaced grooves formed therein, wherein each of the multiple spaced grooves is arranged to receive one of optical diffuser elements of the electro-optical unit, and wherein a distance between two adjacent grooves is equal to a space between the corresponding adjacently received optical diffuser elements. That is, the manufacturing of the electro-optical unit may be implemented by using the frame with multiple spaced grooves. The number of grooves is equal to the number of optical diffuser elements in the electro-optical unit. Notably, the optical diffuser elements are configured to slide in between the multiple spaced grooves. For this purpose, the dimensions of the grooves conform to the dimensions of the corresponding optical diffuser element. Optionally, the frame may be constructed with multiple unequal spaced grooves to accommodate the electro-optical unit with unequal distances between the liquid crystal layers.

The frame may be constructed using at least one of an electrically insulating material, a light absorbing material or a light transparent material. Generally, the frame may be constructed using the electrically insulating material such as a polymer material (for example Polytetrafluoroethylene PTFE). Specifically, the frame may be constructed using the light absorbing material, such as a black polymer material. Alternatively, at least an inner surface of the frame is treated with a light absorbing material, such as the black polymer material and so forth. Furthermore, an outer surface of the optical diffuser elements may be coated with the anti-reflective coating in order to reduce the unwanted reflections when placed in the ambient air surroundings. It will be appreciated that the anti-reflective coatings improve the image contrast and visibility of the imagery content in the brightly lit environments. In another example, the frame may be constructed using the light transparent material, such as an insulating light transparent material. Alternatively, gaps between the outer surface of the optical diffuser elements may be filled with a medium having a refractive index similar to the substrates in contact therewith. Optionally, the medium having the similar refractive index may be resins, glues and so forth in various forms such as solids, viscous form and so forth. The utilization of the medium having the similar refractive index in the gaps ensures a reflectance between two adjacent surfaces to be less than or equal to 0.5%. Therefore, the present electro-optical units comprising such a medium are about 30 times more effective in reducing the unwanted reflections as compared to an electro-optical unit not using the medium.

In an embodiment, the electro-optical unit further comprises a first rigid interlayer laminated to the first optical diffuser element using the first transitional medium layer and positioned between the first optical diffuser element and the second optical diffuser element, wherein a refractive index of the first rigid interlayer is equivalent to the refractive index of the one or more of the second substrate and the third substrate. The first rigid interlayer is configured to provide additional rigidity to the electro-optical unit. Moreover, the construction of the electro-optical unit having the optical diffuser elements at the unequal distances could be achieved using the first rigid interlayer, instead of the construction of the electro-optical unit using customized optical diffuser elements with unequal thickness of the substrates and/or transitional medium layers. Furthermore, the first rigid interlayer provides a support for mounting the electro-optical unit. The first rigid interlayer is laminated to the first optical diffuser element, wherein the lamination is provided using materials such as optically active resins, optical adhesives and so forth. The first rigid interlayer is positioned between the first optical diffuser element and the second optical diffuser element, sometimes arranged inside and passing through the first transitional medium layer. It will be appreciated that the refractive index of the first rigid interlayer is kept similar to the refractive index of the one or more of the second substrate and the third substrate in order to avoid the unwanted reflections.

Furthermore, the electro-optical unit comprises a second rigid interlayer laminated to the second optical diffuser element, wherein a refractive index of the second rigid interlayer is equivalent to a refractive index of the fourth substrate, wherein the first rigid interlayer and the second rigid interlayer are adapted to be coupled together by a fastening arrangement. Moreover, optionally, the fastening arrangement may also be used to couple the electro-optical unit to a mounting assembly or the like in the volumetric display arrangement. The second rigid interlayer is laminated to the second optical diffuser element, wherein the lamination is provided using materials such as optically active resins, optical adhesives and so forth. The second rigid interlayer is positioned between the second optical diffuser element and the third optical diffuser element. It will be appreciated that the refractive index of the second rigid interlayer is kept similar to the refractive index of the one or more of the fourth substrate and the fifth substrate in order to avoid the unwanted reflections. Moreover, the slots for the fastening arrangement are provided at the ends of the rigid interlayer in order to provide a mechanical strength to the electro-optical unit and forming a substantially monolith structure. In an example, the slots may be holes to accommodate the fastening arrangement in the form of screws.

In one or more examples, the rigid interlayers may be constructed using the light transparent materials such as an optical mineral glass, organic compounds such as Polymethyl methacrylate, Cyclo-olefin polymers, polycarbonates and so forth. In one example, the electro-optical unit comprising the rigid interlayers may be constructed by first preparing the optical diffuser element and the rigid interlayers and further laminating them together by using optically transparent adhesive compounds (like, the transitional medium layers) having the similar refractive index. In another embodiment, the electro-optical unit comprising the rigid interlayers may be constructed by preparing a stack of the electro-optical units in a single lamination process. Notably, the rigid interlayers, the optical diffuser elements and the laminations are stacked and pressed together to form the electro-optical unit. In an example, a pressure applied may be 10 kilograms per centimeter square. Such pressure expels the air bubbles trapped in the laminated adhesive layers. Furthermore, optionally, a shape of the rigid interlayers may be varied according to the applications for which the electro-optical unit may be implemented.

Additionally, optionally, the surface of the electro-optical unit that will face the viewer, when implemented in the volumetric display device, may be covered with a protective element (coating), such as a rigid slab, a protective coating in form of the inorganic compounds, the organic compounds, the combination of the organic and the inorganic compounds and so forth.

According to an embodiment, the electro-optical unit may be constructed using double-sided substrates. Herein, the outermost substrates of the electro-optical unit acts as the single-sided substrates, whereas the inner substrates of the electro-optical unit acts as the double-sided substrates with electrodes formed on both sides thereof. The electro-optical unit comprising the double-sided substrates may also comprise the protective layer, the coating on the outermost surfaces, the busbars and so forth. Such double-sided substrates eliminate a need for additional refractive-index matching between the adjacent optical diffuser elements, as each of the double-sided substrate is shared by two liquid crystal layers, therefore, the double-sided substrates act as the supporting structure and also as a spacer separating the two liquid crystal layers. The double-sided substrates may be constructed using materials such as a mineral glass, a fused silica, the optically transparent organic (polymer) materials and so forth. Furthermore, it may be understood that the thickness of the double-sided substrates may be varied in order to vary the distances between the liquid crystal layers. Optionally, the outermost surfaces of the single-sided substrates may be coated with materials such as the anti-reflective coating, the oleophobic coating and so forth. More optionally, the outermost surfaces of the single-sided substrates may be coated with the layer of the transparent toughened material such as a type of a thin-film treatment, an optically transparent sheet such as the tempered glass, a scratch and impact-resistant inorganic or organic material and so forth.

According to an embodiment, the electro-optical unit having a different basic architecture than described above may be constructed. In the following architecture of the electro-optical unit, an optical path from an image projection unit, such as a spatial light modulator, to the electro-optical unit is shortened. Herein, the electro-optical unit exploits the spatial light modulator with a high resolution. Optionally, an aspect-ratio of a pixels of the spatial light modulator is other than 1:1. More optionally, the aspect ratio of the pixels of the spatial light modulator ranges from 1:2 to 1:5. In an example, the spatial light modulator may be a self-light emitting device such as an OLED (organic light emitting diode), a solid-state LED display (including micro displays) and so forth. Optionally, the spatial light modulator can be a conventional-type high-refresh rate liquid crystal display (LCD) panel with a high-brightness backlight. In the present embodiment, a surface of the spatial light modulator is virtually divided into various segments, wherein each of the segment corresponds to a separate image depth plane.

Moreover, the electro-optical unit has a thick structure, wherein the thickness is similar to dimensions of one of the segments of the planar spatial light modulator used for the image projection. The liquid crystal layers in the architecture are tilted with respect to a normal of the planar spatial light modulator (such as the OLED or the LCD display). An angle between the planes of the liquid crystal layers and the normal vector of the spatial light modulator can typically range between 15 and 40 degrees. Furthermore, the optical diffuser elements are constructed to be thin, such as equal to or less than 1 millimeter thick. In such case, a plurality of spacer blocks are used to determine the angle of the optical diffuser elements and thereby, form an optical block by the lamination process. Optionally, the spacer blocks are made from the light transparent solid material and so forth. Moreover, for an adhering of the spacer blocks among themselves and with the optical diffuser elements an optical cement, the polymer resins, optically transparent compounds and so forth may be used. In an example, a cell wall of the optical diffuser element corresponds to the spacer blocks. In such case, a single optical diffuser element is formed from the cell walls and the plurality of liquid crystal layers. Optionally, at least the outer surface of the electro-optical unit facing the viewer is treated with the anti-reflective coating, the oleophobic coating and so forth. Optionally, the outer optical diffuser element arranged furthest away from the eyes of the viewer, such as the third optical diffuser element when the first optical diffuser element is closest to the eyes of the viewer, may be coupled to a separate spatial light modulator (for example, an OLED, an LCD, a solid state micro-LED, and the like), to utilize that outer optical diffuser element as a display by itself; and in such case, that outer optical diffuser element may not require projection of any image depth plane thereon. This is done to achieve high resolution background image depth plane in the volumetric display device.

In one example, the dimensions of the electro-optical units of the present disclosure may be 30×40×10 cubic centimeters or more. More optionally, the electro-optical units may be small in dimension such as having the dimensions of 1×1×1 cubic centimeters, or even less. The smaller electro-optical units typically are intended for the use in wearable 3D display devices such as head mounted displays, near-to eye display devices and so forth.

### DETAILED DESCRIPTION OF THE DRAWINGS

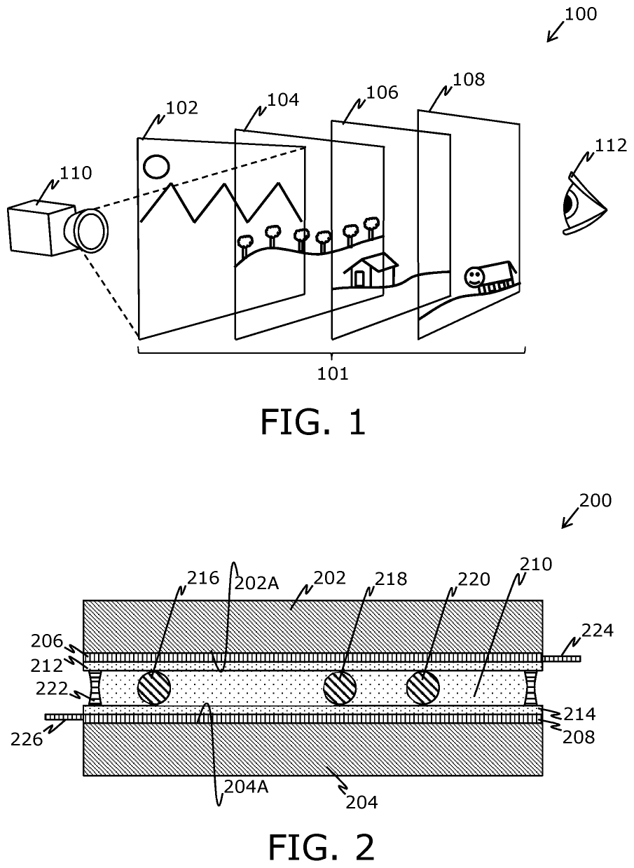

Referring to FIG. 1, there is shown a schematic illustration of a volumetric display device 100 comprising an electro-optical unit 101, in accordance with an embodiment of the present disclosure. The electro-optical unit 101 comprises optical diffuser elements 102, 104, 106, 108 receiving image slices of an image from an image projection unit 110. In particular, an image is portioned into a plurality of image slices (the number of image slices are equal to the number of optical diffuser elements 102, 104, 106, 108). Furthermore, the image projection unit 110 is configured to receive the plurality of image slices, and project on the optical diffuser elements 102, 104, 106, 108. It will be appreciated that one image slice is projected on one of the optical diffuser elements 102, 104, 106, 108. In particular, a depth frame corresponding to subject in the image that is far away therein (such as depicted mountains) is projected on an optical diffuser element that is farthest from a viewer's eye 112 (i.e., the optical diffuser element 102). Furthermore, a depth frame corresponding to subject in the image that is near therein (such as depicted animal) is projected on an optical diffuser element that is closest from the viewer's eye 112 (i.e., the optical diffuser element 108). Such a projection is configured to create a relative depth associated with the 3D image, thereby, creating a 3D image on the electro-optical unit.

Referring to FIG. 2, there is shown an illustration of a cross-section of an optical diffuser element 200, in accordance with an exemplary embodiment of the present disclosure. The optical diffuser element 200 comprises a first substrate 202 and a second substrate 204 arranged opposite to each other. Furthermore, the optical diffuser element 200 comprises a first electrode 206 arranged on an inner side 202A of the first substrate 202 and a second electrode 208 arranged on an inner side 204A of the second substrate 204. Further, a first liquid crystal layer 210 is arranged between the first electrode 206 and the second electrode 208. Furthermore, two dielectric barrier layers 212 and 214 are arranged at a side of the first electrode 206 and the second electrode 208, such that the two dielectric barrier layers 212 and 214 are arranged between the electrodes 206 and 208 and the first liquid crystal layer 210. Moreover, a plurality of spacers 216, 218 and 220 are arranged with the first liquid crystal layer 210. A diameter of the plurality of spacers 216, 218 and 220 is equal to a distance between the two dielectric barrier layers 212 and 214. Furthermore, the optical diffuser element 200 is provided with a seal 222, wherein the seal 222 acts as a closure for the first liquid crystal layer 210 around the perimeter. Moreover, the optical diffuser element 200 is provided with two busbars 224 and 226 arranged in contact with each of the first electrode 206 and the second electrode 208.

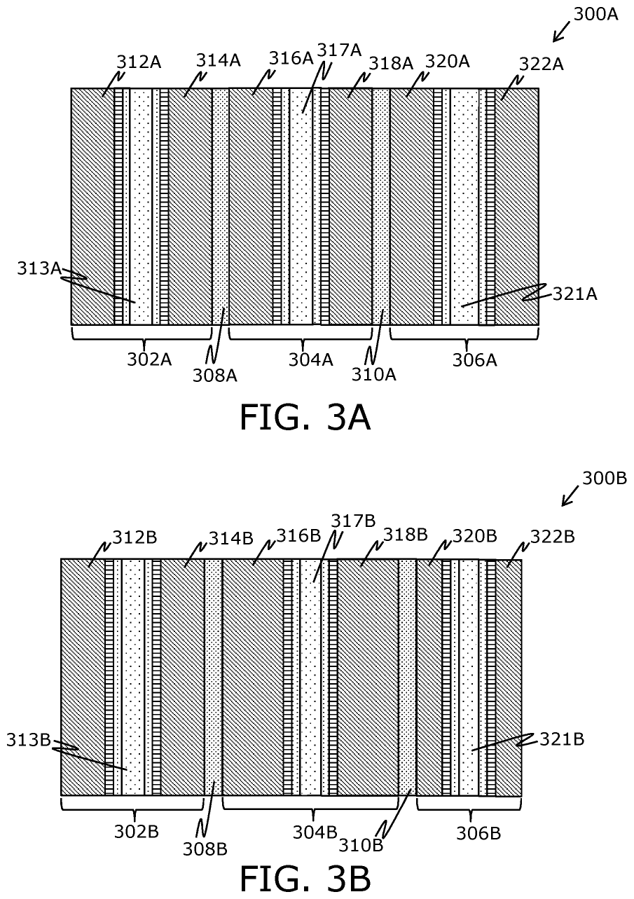

Referring to FIG. 3A, there is shown an illustration of a cross-section of an electro-optical unit 300A, in accordance with an embodiment of the present disclosure. The electro-optical unit 300A is depicted to have three optical diffuser elements, namely a first optical diffuser element 302A, a second optical diffuser element 304A and a third optical diffuser element 306A. Furthermore, a first transitional medium layer 308A is arranged between the first optical diffuser element 302A and the second optical diffuser element 304A, and a second transitional medium layer 310A is arranged between the second optical diffuser element 304A and the third optical diffuser element 306A. The first optical diffuser element 302A comprises a first substrate 312A and a second substrate 314A, with a first liquid crystal layer 313A in between. The second optical diffuser element 304A comprises a third substrate 316A and a fourth substrate 318A, with a second liquid crystal layer 317A in between. The third optical diffuser element 306A comprises a fifth substrate 320A and a sixth substrate 322A, with a third liquid crystal layer 321A in between. It may be seen that the first transitional medium layer 308A is arranged between the second substrate 314A and the third substrate 316A, and the second transitional medium layer 310A is arranged between the fourth substrate 318A and the fifth substrate 320A. Notably, the substrates of the electro-optical unit 300A are equal in dimensions, such as thickness thereof. This makes the distance between the first liquid crystal layer 313A and the second liquid crystal layer 317A equal to a distance between the second liquid crystal layer 317A and the third liquid crystal layer 321A.

Referring to FIG. 3B, there is shown an illustration of a cross-section of an electro-optical unit 300B, in accordance with another embodiment of the present disclosure. The electro-optical unit 300B is depicted to have three optical diffuser elements, namely a first optical diffuser element 302B, a second optical diffuser element 304B and a third optical diffuser element 306B. Furthermore, a first transitional medium layer 308B is arranged between the first optical diffuser element 302B and the second optical diffuser element 304B, and a second transitional medium layer 310B is arranged between the second optical diffuser element 304B and the third optical diffuser element 306B. The first optical diffuser element 302B comprises a first substrate 312B and a second substrate 314B, with a first liquid crystal layer 313B in between. The second optical diffuser element 304B comprises a third substrate 316B and a fourth substrate 318B, with a second liquid crystal layer 317B in between. The third optical diffuser element 306B comprises a fifth substrate 320B and a sixth substrate 322B, with a third liquid crystal layer 321B in between. It may be seen that the first transitional medium layer 308B is arranged between the second substrate 314B and the third substrate 316B, and the second transitional medium layer 310B is arranged between the fourth substrate 318B and the fifth substrate 320B. Notably, the substrates of the electro-optical unit 300B are unequal in dimensions. The first substrate 312B and the second substrate 314B are equal in dimensions, the third substrate 316B and the fourth substrate 318B are equal in dimensions, and the fifth substrate 320B and the sixth substrate 322B are equal in dimensions; however, the third substrate 316B and the fourth substrate 318B have larger thickness as compared to other substrates, whereas the fifth substrate 320B and the sixth substrate 322B have smaller thickness as compared to other substrates. This makes the distance between the first liquid crystal layer 313B and the second liquid crystal layer 317B greater than a distance between the second liquid crystal layer 317B and the third liquid crystal layer 321B.

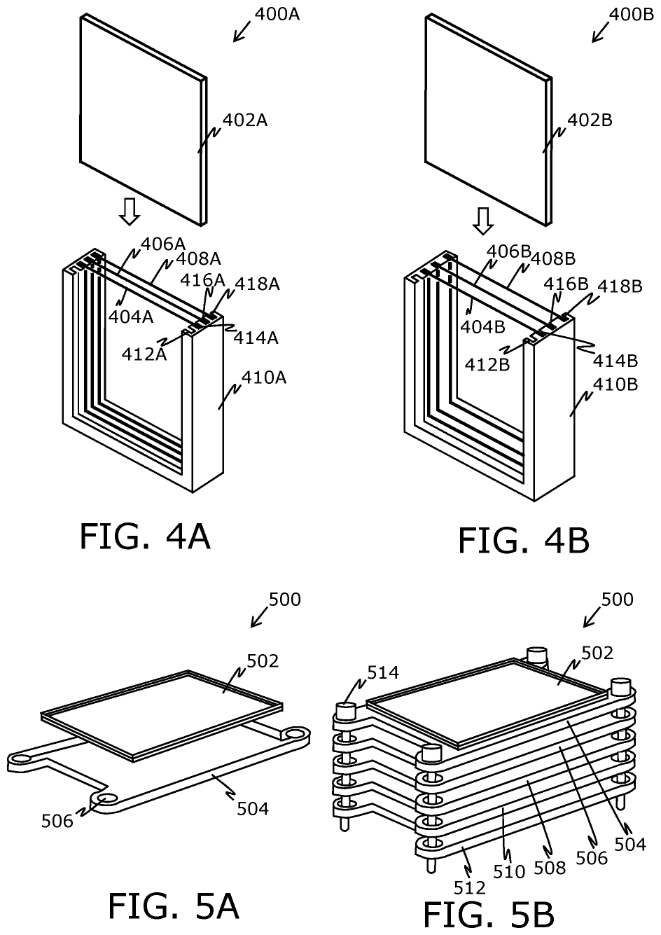

Referring to FIG. 4A, there is shown a schematic illustration of an electro-optical unit 400A comprising optical diffuser elements 402A, 404A, 406A, 408A (in disassembled form, separate from each other) being arranged in a frame 410A having multiple spaced grooves 412A, 414A, 416A, 418A, in accordance with an embodiment of the present disclosure. The frame 410A is shown to have four multiple spaced grooves 412A, 414A, 416A, 418A. Herein, each of the multiple spaced grooves are constructed equidistant from each other. The three grooves 414A, 416A, 418A are depicted holding one of the optical diffuser elements 404A, 406A, 408A, whereas a fourth groove 412A is shown to be unoccupied with the optical diffuser element 402A being placed to be fitted therein.

Referring to FIG. 4B, there is shown a schematic illustration of an electro-optical unit 400B comprising optical diffuser elements 402B, 404B, 406B, 408B in a frame 410B having multiple spaced grooves 412B-418B, in accordance with another embodiment of the present disclosure. The frame 410B is shown to have four multiple spaced grooves 412B, 414B, 416B, 418B. Herein, two or more of the multiple spaced grooves are constructed at an unequal distance with respect to the other. The three multiple spaced grooves 414B, 416B, 418B are depicted holding one of the optical diffuser elements 404B, 406B, 408B, whereas a fourth groove 412B is shown to be unoccupied with the optical diffuser element 402B being placed to be fitted therein.

Referring to FIG. 5A, there is shown an illustration of a partial exploded view of an arrangement of an electro-optical unit 500 comprising an optical diffuser element 502 arranged with respect to a rigid interlayer 504, in accordance with an embodiment of the present disclosure. There is shown the rigid interlayer 504 with slots 506 at each end to couple a plurality of other rigid interlayers therewith. Furthermore, there is shown an optical diffuser element 502 designed to be arranged in the rigid interlayer 504. Herein, the rigid interlayer 504 has a cavity to accommodate the optical diffuser element 502.

Referring to FIG. 5B, there is shown an illustration of an arrangement of the electro-optical unit 500 comprising more optical diffuser elements 502 arranged in rigid interlayers 504, 506, 508, 510, 512, in accordance with an embodiment of the present disclosure. The plurality of rigid interlayers 504, 506, 508, 510, 512 are shown, with each of the rigid interlayer accommodating one optical diffuser element (only one optical diffuser element depicted accommodated on the top most rigid interlayer 502). Furthermore, a fastening arrangement 514 is shown to mate with the slots (such as, slots 506 of FIG. 5A) of the plurality of the rigid interlayers 504, 506, 508, 510, 512 to couple the plurality of the rigid interlayers 504, 506, 508, 510, 512 together.

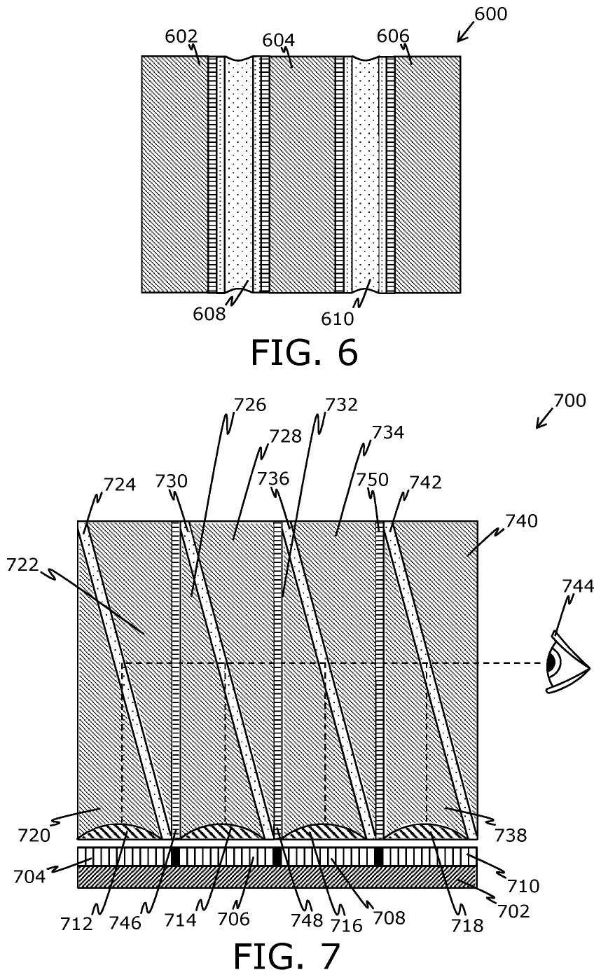

Referring to FIG. 6, there is shown an illustration of an electro-optical unit 600 having double-sided substrates providing two optical diffuser elements, in accordance with an embodiment of the present disclosure. There are shown three substrates 602, 604, 606. Herein the first substrate 602 is single-sided, the second substrate 604 is double-sided and the third substrate 606 is single-sided. Notably, the first substrate 602 and the third substrate 606 are the outer-most substrates, and are thus single-sided structures. Furthermore, the first liquid crystal layer 608 is arranged between the first substrate 602 and the second substrate 604, and the second liquid crystal layer 610 is arranged between the second substrate 604 and the third substrate 606. Such electro-optical unit 600 having double-sided substrates does not require any transitional medium layer therebetween for securing the optical diffuser elements together.

Referring to FIG. 7, there is shown an illustration an electro-optical unit 700, in accordance with another embodiment of the present disclosure. The electro-optical unit 700 comprises a spatial light modulator 702, such as an OLED display, an LED display and so forth. The spatial light modulator 702 is divided into segments 704, 706, 708, 710 corresponding to different image depth planes. Furthermore, a plurality of optical arrangements 712, 714, 716, 718 are provided in order to guide the 3D imagery content from the spatial light modulator 702. A plurality of spacer blocks are arranged above the plurality of optical arrangements 712, 714, 716, 718. A first spacer block comprises a first substrate 720 and a second substrate 722, with a first liquid crystal layer 724 arranged in a tilted manner between the first substrate 720 and the second substrate 722. A second spacer block comprises a third substrate 726 and a fourth substrate 728, with a second liquid crystal layer 730 arranged in a tilted manner between the third substrate 726 and the fourth substrate 728. A third spacer block comprises a fifth substrate 732 and a sixth substrate 734, with a third liquid crystal layer 736 arranged in a tilted manner between the fifth substrate 732 and the sixth substrate 734. A fourth spacer block comprises a seventh substrate 738 and an eighth substrate 740, with a fourth liquid crystal layer 742 arranged in a tilted manner between the seventh substrate 738 and the eighth substrate 740. The spacer blocks are arranged such that a viewer 744 is able to view the imagery content clearly. Furthermore, a first transitional medium layer 746, a second transitional medium layer 748 and a third transitional medium layer 750 is provided between the spacer blocks.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. An electro-optical unit for a volumetric display device, the electro-optical unit comprising:
a first optical diffuser element comprising a first substrate and a second substrate, a first electrode arranged on an inner side of the first substrate and a second electrode arranged on an inner side of the second substrate, and a first liquid crystal layer arranged between the first electrode and the second electrode;
a second optical diffuser element comprising a third substrate and a fourth substrate, a third electrode arranged on an inner side of the third substrate and a fourth electrode arranged on an inner side of the fourth substrate, and a second liquid crystal layer arranged between the third electrode and the fourth electrode, wherein the second optical diffuser element is arranged spaced apart from the first optical diffuser element such that the second substrate and the third substrate are facing each other; and
a first transitional medium layer arranged between the first optical diffuser element and the second optical diffuser element to be in contact with an outer side of the second substrate and an outer side of the third substrate therein, wherein the first transitional medium layer has a refractive index equivalent to a refractive index of one or more of the second substrate and the third substrate,
wherein the refractive indexes of the second substrate and the third substrate are equivalent to refractive indexes of the respective first liquid crystal layer and the second liquid crystal layer in the substantially transparent optical states thereof.

2. An electro-optical unit according to claim 1, wherein the first liquid crystal layer and the second liquid crystal layer are configured to independently switch between a substantially transparent optical state and a substantially diffusing optical state upon application of different voltage values thereto.

3. An electro-optical unit according to claim 1, further comprising:
a third optical diffuser element comprising a fifth substrate and a sixth substrate, a fifth electrode arranged on an inner side of the fifth substrate and a sixth electrode arranged on an inner side of the sixth substrate, and a third liquid crystal layer arranged between the fifth electrode and the sixth electrode, wherein the third optical diffuser element is arranged spaced apart from the second optical diffuser element such that the fourth substrate and the fifth substrate are facing each other; and
a second transitional medium layer arranged between the second optical diffuser element and the third optical diffuser element to be in contact with an outer side of the fourth substrate and an outer side of the fifth substrate therein, wherein the second transitional medium layer has a refractive index equivalent to a refractive index of one or more of the fourth substrate and the fifth substrate.

4. An electro-optical unit according to claim 3, wherein the third liquid crystal layer is configured to switch between a substantially transparent optical state and a substantially diffusing optical state upon application of different voltage values thereto, and wherein the refractive index of the fifth substrate is equivalent to a refractive index of the third liquid crystal layer in the substantially transparent optical state thereof.

5. An electro-optical unit according to claim 1, wherein the first optical diffuser element comprises at least one dielectric barrier layer arranged between the first electrode and the first liquid crystal layer, and is arranged in contact with the first electrode at a first side thereof and the first liquid crystal layer at a second side thereof.

6. An electro-optical unit according to claim 5, wherein a refractive index of the at least one dielectric barrier layer is tuned to gradually vary between the first side and the second side thereof, to be matched to one or more of the refractive indexes of the first electrode and of the first liquid crystal layer at respective sides thereof.

7. An electro-optical unit according to claim 5, wherein a value of refractive index of the at least one dielectric barrier layer is between values of the refractive indexes of the first electrode and of the first liquid crystal layer at respective sides thereof.

8. An electro-optical unit according to claim 1, wherein an outer side of the first substrate is provided with one or more of an anti-reflective coating, an oleophobic coating, a hydrophobic coating and a tempered glass.

9. An electro-optical unit according to claim 1, wherein the first transitional medium layer comprises one or more of an optically transparent viscous resin and an optically transparent adhesive to hold the first optical diffuser element and the second optical diffuser element together.

10. An electro-optical unit according to claim 1, wherein the optical diffuser elements are held together to form a monolith structure.

11. An electro-optical unit according to claim 3, wherein the first liquid crystal layer and the second liquid crystal layer, and the second liquid crystal layer and the third liquid crystal layer are arranged
equidistant from each other, or
at different distances from each other.

12. An electro-optical unit according to claim 11, wherein a thickness of one or more of the second substrate and the third substrate is in the range of 0.15 to 2 millimeters, and a thickness of one or more of the fourth substrate and the fifth substrate is equal to or more than the thickness of one or more of the second substrate and the third substrate.

13. An electro-optical unit according to claim 11, wherein a thickness of the first transitional medium layer is in the range of 0.05 to 0.2 millimeters and a thickness of the second transitional medium layer is equal to or more than the thickness of the first transitional medium layer.

14. An electro-optical unit according to claim 1, further comprising a frame constructed using at least one of an electrically insulating material, a light absorbing material or a light transparent material and having multiple spaced grooves formed therein, wherein each of the multiple spaced grooves is arranged to receive one of optical diffuser elements of the electro-optical unit, and wherein a distance between two adjacent grooves is equal to a distance between the corresponding adjacently received optical diffuser elements.

15. An electro-optical unit according to claim 1, further comprising:
a first rigid interlayer laminated to the first optical diffuser element using the first transitional medium layer and positioned between the first optical diffuser element and the second optical diffuser element, wherein a refractive index of the first rigid interlayer is equivalent to the refractive index of the one or more of the second substrate and the third substrate; and
a second rigid interlayer laminated to the second optical diffuser element, wherein a refractive index of the second rigid interlayer is equivalent to a refractive index of the fourth substrate,
wherein the first rigid interlayer and the second rigid interlayer are adapted to be coupled together by a fastening arrangement.
